(19) United States
(12) Patent Application Publication
(10) Pub. No.: US 2025/0293608 A1
(43) Pub. Date: Sep. 18, 2025

(54) VOLTAGE CONVERSION CIRCUIT WITH OUTPUT CURRENT LIMITATION AND METHOD THEREOF

(71) Applicant: Chengdu Monolithic Power Systems Co., Ltd., Chengdu (CN)

(72) Inventors: Xia Zhou, Hangzhou (CN); Hui Li, Hangzhou (CN); Xuefeng Chen, Hangzhou (CN)

(21) Appl. No.: 19/076,396

(22) Filed: Mar. 11, 2025

(30) Foreign Application Priority Data
Mar. 12, 2024 (CN) 202410284578.8

(51) Int. Cl. H02M 3/335; H02M 1/00; H02M 1/08

(52) U.S. Cl. CPC H02M 3/33576; H02M 1/0058; H02M 1/08

(57) ABSTRACT

A control circuit for a voltage conversion circuit is provided. The control circuit includes a duty cycle control circuit, a feedback frequency control circuit and a secondary driving control circuit. The duty cycle control circuit provides a switching time control signal based on an on-period of a secondary switch of the voltage conversion circuit. The switching time control signal indicates a first duration. The feedback frequency control circuit provides a feedback frequency control signal based on a feedback signal operable to indicate a load of the voltage conversion circuit. The feedback frequency control signal indicates a second duration. The secondary driving control circuit provides a switching release signal based on the switching time control signal and the feedback frequency control signal. The switching release signal turns on a primary switch of the voltage conversion circuit in response to the first duration and the second duration.

### CROSS-REFERENCE TO RELATED APPLICATIONS

This application claims the benefit of and priority to a CN application Ser. No. 202410284578.8, filed on Mar. 12, 2024, which is incorporated herein by reference into the present application.

### TECHNICAL FIELD

The present disclosure relates generally to electronic circuits, and more particularly but not exclusively to voltage conversion circuits with output current limitation and associated methods.

### BACKGROUND OF THE INVENTION

Voltage conversion circuit converts an AC or DC input voltage into a suitable DC output voltage to power electronic devices. Isolated voltage conversion circuit has an isolated device between a primary circuit and a secondary circuit. The primary circuit controls the input power of the isolated voltage conversion circuit by adjusting the duty cycle of a primary power switch of the primary circuit. The input power is transferred through the isolated device to the secondary circuit to generate the output power. The output power is provided to an electronic device coupled to the secondary circuit.

During operation of the isolated voltage conversion circuit, in order to prevent the electronic device from being damaged by the large output power, the isolated voltage conversion circuit is often designed with over-power protection to limit the maximum output power of the isolated voltage conversion circuit. However, in some applications, the output voltage of the isolated voltage conversion circuit varies in a wide range. In this case, when the output voltage of the isolated voltage conversion circuit is low, the upper limit of the output current determined by the maximum output power is large, and the electronic device may be damaged by the large output current. Therefore, it is necessary to limit the output current of the isolated voltage conversion circuit under low output voltage condition, to protect the electronic device.

### SUMMARY OF THE INVENTION

According to an embodiment of the present disclosure, a control circuit for a voltage conversion circuit is provided. The control circuit includes a duty cycle control circuit, a feedback frequency control circuit and a secondary driving control circuit. The duty cycle control circuit provides a switching time control signal based on an on-period of a secondary switch of the voltage conversion circuit. The switching time control signal indicates a first duration. The feedback frequency control circuit provides a feedback frequency control signal based on a feedback signal operable to indicate a load of the voltage conversion circuit. The feedback frequency control signal indicates a second duration. The secondary driving control circuit provides a switching release signal based on the switching time control signal and the feedback frequency control signal. The switching release signal turns on a primary switch of the voltage conversion circuit in response to the first duration and the second duration.

According to another embodiment of the present disclosure, a voltage conversion circuit is provided. The voltage conversion circuit includes a primary switch, a secondary switch and a transformer. The primary switch receives a primary switch control signal and is controlled by the primary switch control signal. The secondary switch receives a secondary switch control signal and is controlled by the secondary switch control signal. The transformer has a primary winding and a secondary winding. The primary winding is coupled in series with the primary switch, and the secondary winding is coupled in series with the secondary switch. The control circuit includes a duty cycle control circuit, a feedback frequency control circuit and a secondary driving control circuit. The duty cycle control circuit provides a switching time control signal based on an on-period of the secondary switch. The switching time control signal indicates a first duration. The feedback frequency control circuit provides a feedback frequency control signal based on a feedback signal operable to indicate a load of the voltage conversion circuit. The feedback frequency control signal indicates a second duration. The secondary driving control circuit provides a switching release signal based on the switching time control signal and the feedback frequency control signal. The switching release signal turns on the primary switch in response to the first duration and the second duration.

According to yet another embodiment of the present disclosure, a method for controlling a voltage conversion circuit is provided. The method includes following actions. A first duration is generated based on an on-period of a secondary switch of the voltage conversion circuit. A second duration is generated based on a feedback signal operable to indicate a load of the voltage conversion circuit. A primary switch of the voltage conversion circuit is turned on based on the first duration and the second duration.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the device and are not necessarily drawn to scale.

FIG. 1 schematically shows a power system in accordance with one embodiment of the present disclosure.

FIG. 2 schematically shows a power system in accordance with one embodiment of the present disclosure.

FIG. 3 schematically show a secondary control circuit in accordance with one embodiment of the present disclosure.

FIG. 4 schematically shows waveforms of signals of the power system as shown in FIG. 2 in accordance with one embodiment of the present disclosure.

FIG. 5 schematically shows a secondary control circuit in accordance with one embodiment of the present disclosure.

FIG. 6 schematically shows waveforms of signals of the power system as shown in FIG. 2 in accordance with one embodiment of the present disclosure.

FIG. 7 schematically shows a power system in accordance with one embodiment of the present disclosure.

FIG. 8 schematically shows a secondary control circuit in accordance with one embodiment of the present disclosure.

FIG. 9 schematically shows waveforms of signals of the power system as shown in FIG. 2 in accordance with one embodiment of the present disclosure.

FIG. 10 schematically shows a secondary control circuit in accordance with one embodiment of the present disclosure.

FIG. 11 shows a flowchart of a method for controlling a voltage conversion circuit in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

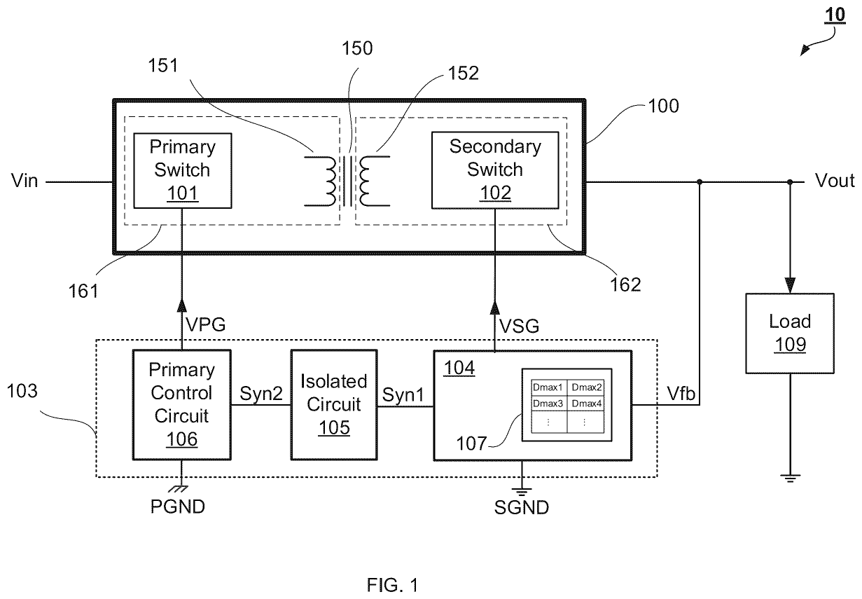

FIG. 1 schematically shows a power system 10 in accordance with one embodiment of the present disclosure. As shown in FIG. 1, the power system 10 includes a voltage conversion circuit 100 and a control circuit 103 for controlling the voltage conversion circuit 100. The voltage conversion circuit 100 is configured to receive an input voltage Vin, and to provide an output voltage Vout to power a load 109. The load 109 may include any suitable applicable device, such as a laptop, a mobile phone and a power bank. In one embodiment, the input voltage Vin is a DC voltage provided by a pre-stage circuit. In another embodiment, the input voltage Vin is a DC voltage obtained by rectifying an AC voltage provided by the power grid. In yet another embodiment, the input voltage Vin is a voltage provided by a battery or other power device.

In the embodiment of FIG. 1, the voltage conversion circuit 100 includes a transformer 150, a primary switch 101 and a secondary switch 102. The transformer 150 includes a primary winding 151 and a secondary winding 152. A primary circuit 161 includes the primary switch 101, the primary winding 151, and other circuit elements coupled to the primary switch 101 or the primary winding 151. A secondary circuit 162 includes the secondary switch 102, the secondary winding 152, and other circuit elements coupled to the secondary switch 102 or the secondary winding 152. In the embodiment of FIG. 1, the primary circuit 161 is configured to receive the input voltage Vin, and to store energy in the primary winding 151. The secondary circuit 162 is configured to receive energy through the secondary winding 152, to provide the output voltage Vout, and to provide the received energy to the load 109.

In the embodiment of FIG. 1, the control circuit 103 includes a secondary control circuit 104, an isolated circuit 105 and a primary control circuit 106. The primary control circuit 106 is configured to provide a primary switch control signal VPG to control the primary switch 101. The secondary control circuit 104 is configured to provide a secondary switch control signal VSG to control the secondary switch 102. The isolated circuit 105 is configured to provide communication between the primary control circuit 106 and the secondary control circuit 104.

In the embodiment of FIG. 1, the secondary control circuit 104 includes a duty cycle control circuit 107. The duty cycle control circuit 107 is configured to limit the duty cycle D of the secondary switch 102 to a maximum duty cycle Dmax. The duty cycle D of the secondary switch 102 refers to, for a switching cycle, the ratio of an on-period Ton of the secondary switch 102 to a switching period of the secondary switch 102 (i.e., the switching period Ts of the voltage conversion circuit 100), which could be expressed by: D=Ton/Ts. The duty cycle control circuit 107 is configured to detect the on-period Ton of the secondary switch 102 (e.g., the on-period Ton could be obtained by detecting the secondary switch control signal VSG), and to calculate a limited value T1 of the switching period Ts based on the on-period Ton, i.e., T1=Ton/Dmax. The limited value T1 of the switching period Ts is also referred to a first duration T1.

In the embodiment of FIG. 1, the secondary control circuit 104 is configured to detect the condition of the load 109, and to provide the secondary switch control signal VSG to control the secondary switch 102 based on a load detecting signal Vfb indicating the condition of the load 109. Meanwhile, the secondary control circuit 104 is configured to provide a switching release signal Syn1 to control the primary switch 101 for controlling the switching period Ts of the voltage conversion circuit 100. In some embodiments, when the load 109 transitions from light load to heavy load, the switching period Ts of the voltage conversion circuit 100 decreases, and the switching frequency increases, such that the output current increases to meet the load requirement. Since the upper limit of the output current of the voltage conversion circuit 100 is determined by the over-power protection design, the upper limit of the output current is large when the output voltage Vout is low. In other words, when the load 109 becomes heavier and the output voltage Vout is low, the output current may not be limited by the over-power protection and be too large to damage the load 109. To limit the output current of the voltage conversion circuit 100, the switching period Ts of the voltage conversion circuit 100 is limited to the first duration T1=Ton/Dmax, that is, the switching frequency is limited within a certain range, and therefore the output current of the voltage conversion circuit 100 is limited.

In some embodiments, the maximum duty cycle Dmax may be set by circuit design. In some other embodiments, the maximum duty cycle Dmax may be set by users via a data interface. In one embodiment, the maximum duty cycle Dmax is a constant value, which is determined based on the circuit parameters in practical applications. For example, the maximum duty cycle Dmax could be expressed as: Dmax=Io_max/(0.5×N×Ip_pk), where Io_max is the a limited maximum output current, N is the turns ratio of the primary winding 151 to the secondary winding 152 of the transformer 150, and Ip_pk is the peak value of the current flowing through the primary winding 151 (i.e., primary peak current). In some embodiments, the primary peak current Ip_pk is a constant value. In some embodiments, the primary peak current Ip_pk increases as the load increases. In one embodiment, the maximum duty cycle Dmax is selected from a plurality of constant values (e.g., Dmax1, Dmax2, Dmax3, Dmax4 . . . as shown in FIG. 1). In some embodiments, the plurality of constant values may be selected based on the circuit parameters of the voltage conversion circuit 100, for example, the output voltage Vout. In other embodiments, the plurality of constant values may be selected based on the corresponding data received from the digital interface.

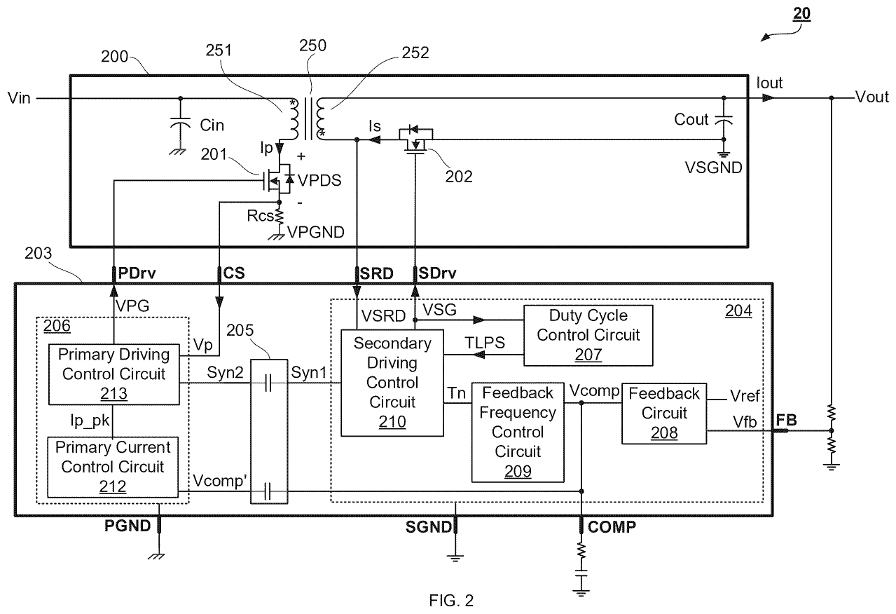

The voltage conversion circuit 100 may be an isolated switching circuit or a non-isolated switching circuit. When the voltage conversion circuit 100 is the isolated switching circuit, the voltage conversion circuit 100 may have different topologies, such as a flyback topology, a forward topology and an asymmetrical half-bridge flyback topology. FIG. 2 schematically shows a power system 20 in accordance with one embodiment of the present disclosure. In FIG. 2, the power system 20 includes a voltage conversion circuit 200 and a control circuit 203. The voltage conversion circuit 200 has the flyback topology.

In the embodiment of FIG. 2, the voltage conversion circuit 200 includes a transformer 250, a primary switch 201 and a secondary switch 202. The transformer 250 includes a primary winding 251 and a secondary winding 252. The primary switch 201 is coupled to the primary winding 251, and the secondary switch 202 is coupled to the secondary winding 252. When the primary switch 201 is turned on, a primary current Ip flows through the primary winding 251 and the primary switch 201, the primary winding 251 stores energy. When the primary switch 201 is turned off, the secondary switch 202 is turned on, and the energy stored in the primary winding 251 is transferred to the secondary winding 252, thus the stored energy could be provided to the load (e.g., the load 109 as shown in FIG. 1). In FIG. 2, the voltage conversion circuit 200 further includes an input capacitor Cin and an output capacitor Cout, which are used to filter and stabilize the voltage at the input and output terminals of the voltage conversion circuit 200, respectively.

In the embodiment of FIG. 2, the control circuit 203 includes a primary control circuit 206, an isolated circuit 205 and a secondary control circuit 204. The secondary control circuit 204 is configured to provide the switching release signal Syn1 to the primary control circuit 206 through the isolated circuit 205, for turning on the primary switch 201.

In the embodiment of FIG. 2, the secondary control circuit 204 includes a duty cycle control circuit 207, a feedback circuit 208, a feedback frequency control circuit 209 and a secondary driving control circuit 210.

The duty cycle control circuit 207 is configured to provide a switching time control signal TLPS based on the on-period Ton of the secondary switch 202. In the embodiment of FIG. 2, the duty cycle control circuit 207 obtains the on-period Ton of the secondary switch 202 based on the second switch control signal VSG. It should be appreciated that, in the specific circuit, the on-period Ton of the secondary switch 202 could be indicated by other signals, for example, the logic signals having similar waveforms to the secondary switch control signal VSG. In other embodiments, in addition to the secondary switch control signal VSG, the duty cycle control circuit 207 may obtain the on-period Ton of the secondary switch 202 based on other signals. For example, in some embodiments, the on-period Ton of the secondary switch 202 may be obtained by detecting the voltage of an additional auxiliary winding or a primary switch voltage VPDS across the primary switch 201. The switching time control signal TLPS indicates the first duration T1. In other words, the switching time control signal TLPS includes the information of the first duration T1. Under some operating conditions of the voltage conversion circuit 200, for example, when the output voltage Vout is low, the switching period Ts of the voltage conversion circuit 200 is controlled based on the first duration T1.

The feedback circuit 208 is configured to receive the load detecting signal Vfb, and to provide a feedback signal Vcomp based on the load detecting signal Vfb. In some embodiments, the load detecting signal Vfb indicates the output voltage Vout of the voltage conversion circuit 200. In some embodiments, the feedback circuit 208 includes an error amplifying circuit. The error amplifying circuit is configured to provide the feedback signal Vcomp to indicate the load condition based on the difference between the load detecting signal Vfb and a reference signal Vref. In some embodiments, when the load increases, the output voltage Vout decreases, the load detecting signal Vfb decreases, and the feedback signal Vcomp increases. In some other embodiments, when the load decreases, the output voltage Vout increases, the load detecting signal Vfb increases, and the feedback signal Vcomp decreases. In other embodiments, the load detecting signal Vfb may indicate the output current Iout of the voltage conversion circuit 200. The feedback signal Vcomp indicates the load condition. The acquisition of the feedback signal Vcomp is not limited to the illustrated embodiment of the present disclosure. Other feedback signals indicating the load condition of the voltage conversion circuit 200 may be used as the feedback signal Vcomp in the embodiment of the present disclosure.

The feedback frequency control circuit 209 is configured to provide a feedback frequency control signal Tn based on the feedback signal Vcomp. The feedback frequency control signal Tn indicates a second duration T2. When the first duration T1 and the second duration T2 both end, the switching release signal Syn1 is enabled, indicating that the primary switch 101 could be turned on. The second duration T2 varies with the feedback signal Vcomp. For example, when the feedback signal Vcomp increases, the second duration T2 decreases, the switching period Ts of the voltage conversion circuit 200 decreases, and the switching frequency increases. In another example, when the feedback signal Vcomp decreases, the second duration T2 increases, the switching period Ts of the voltage conversion circuit 200 increases, and the switching frequency decreases.

In different embodiments, the start times of the first duration T1 and the second duration T2 may be different. In other words, the first duration T1 and the second duration T2 could start from different time. In some embodiments, the first duration T1 starts from the time when the switching release signal Syn1 is enabled, after the first duration T1 ends, the first duration T1 starts again from the adjacent next time when the switching release signal Syn1 is enabled. In some embodiments, the second duration T2 and the first duration T1 may start at the same time, that is, the second duration T2 starts from the time when the switching release signal Syn1 is enabled, after the second duration T2 ends, the second duration T2 starts again from the adjacent next time when the switching release signal Syn1 is enabled. In other embodiments, the second duration T2 starts from the turn-off time of the primary switch 201, after the second duration T2 ends, the second duration T2 starts again from the adjacent next turn-off time of the primary switch 201. In other embodiments, the start time of the second duration T2 may be other suitable time of the switching cycle.

It should be appreciated that, the relationship between the length of the second duration T2 and the feedback signal Vcomp is different when the start time of the second duration T2 is different. For example, the second duration T2 whose start time is the turn-on time of the primary switch 201 is longer than the second duration T2 whose start time is the turn-off time of the primary switch 201. It should be appreciated that, the turn-on time of the primary switch 201 refers the moment when the primary switch 201 is turned on and the turn-off time of the primary switch 201 refers the moment when the primary switch 201 is turned off.

The secondary driving control circuit 210 is configured to receive a secondary switch voltage VSRD of the secondary switch 202, the switching time control signal TLPS and the feedback frequency control signal Tn. The secondary driving control circuit 210 is configured to provide the secondary switch control signal VSG to control the secondary switch 202 based on the secondary switch voltage VSRD. Furthermore, the secondary driving control circuit 210 is configured to provide the switching release signal Syn1 to turn on the primary switch 201 of the voltage conversion circuit 200 based on the switching time control signal TLPS and the feedback frequency control signal Tn.

The isolated circuit 205 is configured to provide the switching release signal Syn1 from the secondary control circuit 204 to the primary control circuit 206. Furthermore, the isolated circuit 205 is configured to provide the feedback signal Vcomp from the secondary control circuit 204 to the primary control circuit 206. It should be appreciated that, FIG. 2 shows some of the signals that need to be transmitted via the isolated circuit 205. In other embodiments, more signals may be transmitted between the primary control circuit 206 and the secondary control circuit 204 through the isolated circuit 205. In the embodiment of FIG. 2, the isolated circuit 205 includes a capacitor. It should be appreciated that, in other embodiments, the isolated circuit 205 may also utilize other isolated devices, for example, an optocoupler or a transformer.

The signal forms of the switching release signal Syn1 and the feedback signal Vcomp provided by the isolated circuit 205 may change. In other words, the signal forms of the switching release signal Syn1 and the feedback signal Vcomp provided by the secondary control circuit 204 may not be consistent with the signal forms of a switching release signal Syn2 and a feedback signal Vcomp′ received by the primary control circuit 206. For example, the voltage level of the switching release signal Syn1 (the feedback signal Vcomp) is different from that of the switching release signal Syn2 (the feedback signal Vcomp′). In another example, the switching release signal Syn2 (the feedback signal Vcomp′) is the complementary signal of the switching release signal Syn1 (the feedback signal Vcomp). In yet another example, there is a certain delay between the switching release signal Syn1 (the feedback signal Vcomp) and the switching release signal Syn2 (the feedback signal Vcomp′). However, it should be appreciated that the information of the switching release signal Syn2 and the feedback signal Vcomp′ received by the primary control circuit 206 is consistent with that of the switching release signal Syn1 and the feedback signal Vcomp provided by the secondary control circuit 204.

The primary control circuit 206 is configured to receive the switching release signal Syn2, and to provide the primary switch control signal VPG to turn on the primary switch 201 based on the switching release signal Syn2. In some embodiments, the primary switch control signal VPG turns off the primary switch 201 when the primary current Ip increases to the primary peak current Ip_pk. The primary control circuit 206 includes a primary current control circuit 212 and a primary driving control circuit 213. In the embodiment of FIG. 2, the primary current control circuit 212 is configured to generate the primary peak current Ip_pk based on the received feedback signal Vcomp′. The primary peak current Ip_pk increases as the feedback signal Vcomp increases. In other words, the primary peak current Ip_pk increases when the load increases.

The primary driving control circuit 213 is configured to provide the primary switch control signal VPG based on a current sense signal Vp, the primary peak current Ip_pk and the switching release signal Syn2. When the switching release signal Syn2 indicates that the primary switch 201 could be turned on, the primary switch control signal VPG turns on the primary switch 201, the primary current Ip increases. When the current sense signal Vp indicates that the primary current Ip increases to the primary peak current Ip_pk, the primary switch control signal VPG turns off the primary switch 201. In some embodiments, the primary peak current Ip_pk may be a constant value, which is determined according to the specifications and requirements of practical applications. In these embodiments, the primary peak current Ip_pk may not need to be generated based on the feedback signal Vcomp′, and the feedback signal Vcomp may not need to be provided by the isolated circuit 205. In the embodiment of FIG. 2, the primary peak current Ip_pk is generated based on the feedback signal Vcomp′, i.e., the primary peak current Ip_pk is associated with the load condition. To be specific, the primary peak current Ip_pk increases when the load increases, and the primary peak current Ip_pk decreases when the load decreases. As shown in FIG. 2, the feedback of the load is realized by providing the feedback signal Vcomp from the secondary control circuit 204 through the isolated circuit 205 to the primary control circuit 206. It should be appreciated that the feedback of the load may also be realized in other ways that are well known to those skilled in the art and will not be described herein.

In the embodiment of FIG. 2, the primary control circuit 206, the isolated circuit 205 and the secondary control circuit 204 are integrated in an integrated circuit (IC). In other words, the control circuit 203 is integrated in the IC. The IC includes a pin PDrv, a pin CS, a pin SRD, a pin SDrv, a pin FB, a pin PGND, a pin SGND and a pin COMP.

The pin PDrv is configured to provide the primary switch control signal VPG to control the primary switch 201. The pin CS is configured to receive the current sense signal Vp indicating the primary current Ip. The pin SRD is coupled to the drain terminal of the secondary switch 202 to receive the secondary switch voltage VSRD across the secondary switch 202. Due to the source terminal of the secondary switch 202 is coupled to a secondary ground VSGND, the voltage at the drain terminal of the secondary switch 202 indicates the secondary switch voltage VSRD across the secondary switch 202. The pin SDrv is configured to provide the secondary switch control signal VSG to control the secondary switch 202. The pin FB is configured to receive the load detecting signal Vfb. In the embodiment of FIG. 2, the pin FB is coupled to the output terminal of the voltage conversion circuit 200 via a resistor network to receive the output voltage Vout. It should be appreciated that other conventional load detecting methods may also be used in the present disclosure. The pin PGND is coupled to the primary ground VPGND for providing a ground voltage to the primary control circuit 206. The pin SGND is coupled to the secondary ground VSGND for providing a ground voltage to the secondary control circuit 206. The pin COMP is coupled to a compensation circuit located outside of the IC. In the embodiment shown in FIG. 2, the compensation circuit includes a resistor and a capacitor.

It should be appreciated that, some or all of the primary control circuit 206, the isolated circuit 205 and the secondary control circuit 204 are integrated in the same IC. In another embodiment, they are integrated independently in different ICs. Furthermore, in some embodiments, the primary switch 201 may be integrated with the primary control circuit 206 in the same IC. Similarly, the secondary switch 202 may be integrated with the secondary control circuit 204 in the same IC.

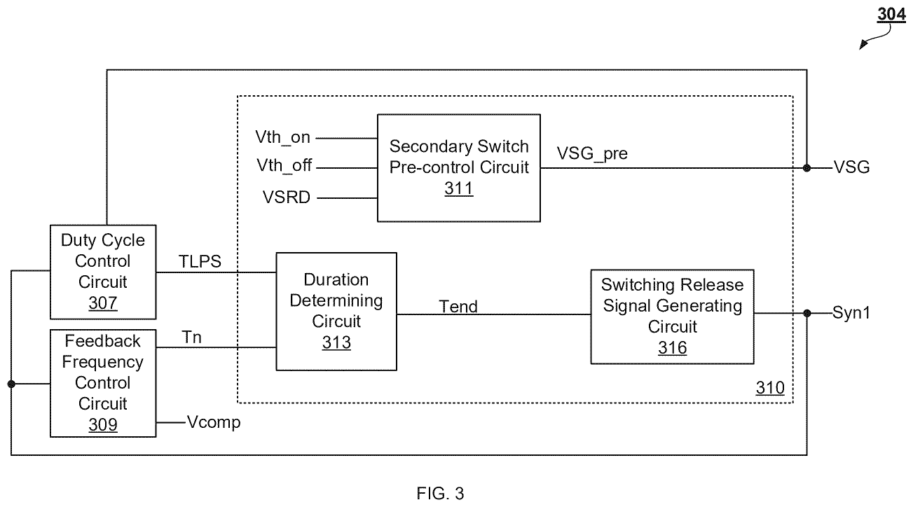

FIG. 3 schematically show a secondary control circuit 304 in accordance with one embodiment of the present disclosure. The secondary control circuit 304 may be used in the power system 20 as shown in FIG. 2. The secondary control circuit 304 includes a duty cycle control circuit 307, a feedback frequency control circuit 309 and a secondary driving control circuit 310.

The duty cycle control circuit 307 is configured to provide the switching time control signal TLPS based on the on-period Ton of the secondary switch 202. The switching time control signal TLPS indicates the first duration T1. In the embodiment of FIG. 3, the on-period Ton of the secondary switch 202 is detected based on the secondary switch control signal VSG. Meanwhile, the duty cycle control circuit 307 is configured to set the start time of the first duration T1 based on the switching release signal Syn1. That is, the first duration T1 starts from the time when the switching release signal Syn1 indicates that the primary switch 201 could be turned on. After the first duration T1 ends, the first duration T1 starts again at the next time when the switching release signal Syn1 indicates that the primary switch 201 could be turned on.

The feedback frequency control circuit 309 is configured to provide the feedback frequency control signal Tn based on the feedback signal Vcomp and the switching release signal Syn1. The feedback frequency control signal Tn indicates the second duration T2. The length of the second duration T2 is determined by the feedback signal Vcomp. In the embodiment of FIG. 3, the start time of the second duration T2 is the time when the switching release signal Syn1 indicates that the primary switch 201 could be turned on. In one embodiment, the feedback frequency control circuit 309 includes a voltage-controlled oscillator and a timing circuit. The voltage-controlled oscillator is configured to generate the second duration T2 based on the feedback signal Vcomp. The timing circuit is configured to start timing from the time when the switching release signal Syn1 indicates that the primary switch 201 could be turned on, and to provide the feedback frequency control signal Tn to indicate the end of the second duration T2.

The secondary driving control circuit 310 includes a secondary switch pre-control circuit 311, a duration determining circuit 313 and a switching release signal generating circuit 316.

The secondary switch pre-control circuit 311 is configured to provide a secondary switch pre-control signal VSG_pre based on the secondary switch voltage VSRD, a secondary switch on threshold Vth_on and a secondary switch off threshold Vth_off. In one embodiment, the secondary switch pre-control circuit 311 includes a comparison circuit. The comparison circuit is configured to set the secondary switch pre-control signal VSG_pre to a first voltage level when the secondary switch voltage VSRD decreases to the secondary switch on threshold Vth_on, and to set the secondary switch pre-control signal VSG_pre to a second voltage level when the secondary switch voltage VSRD increases to the secondary switch off threshold Vth_off. In one embodiment, the first voltage level may correspond to a voltage level (e.g., high voltage level) and the second voltage level may correspond to another voltage level (e.g., low voltage level). It should be appreciated that, as previously described, in other embodiments, the secondary switch pre-control signal VSG_pre may also be obtained in other ways. For example, the secondary switch pre-control signal VSG_pre could be obtained by detecting the slew rate and the value of the secondary switch voltage VSRD, such that the secondary switch 202 could be controlled accurately to prevent the false triggering. In another example, the secondary switch 202 may be controlled based on the secondary current Is.

In the embodiment of FIG. 3, the secondary switch pre-control signal VSG_pre provided by the secondary switch pre-control circuit 311 is used directly as the secondary switch control signal VSG for controlling the secondary switch 202.

The duration determining circuit 313 is configured to provide a switching time pre-determining signal Tend based on the switching time control signal TLPS and the feedback frequency control signal Tn. In one embodiment, the switching time pre-determining signal Tend provides a pulse to indicate the time when the first duration T1 indicated by the switching time control signal TLPS and the second duration T2 indicated by the feedback frequency control signal Tn both end. It is to be appreciated that the switching time pre-determining signal Tend may utilize other forms to indicate the time when the first duration T1 and the second duration T2 both end, for example, a specific state of the signal. The specific state of the signal may include, but not limited to, the rising edge, the falling edge, the specific voltage level, the specific value, or any indication of the time when the first duration T1 and the second duration T2 both end.

The switching release signal generating circuit 316 is configured to generate the switching release signal Syn1 based on the switching time pre-determining signal Tend. In one embodiment, after the first duration T1 and the second duration T2 both end, the switching release signal Syn1 turns on the primary switch 201.

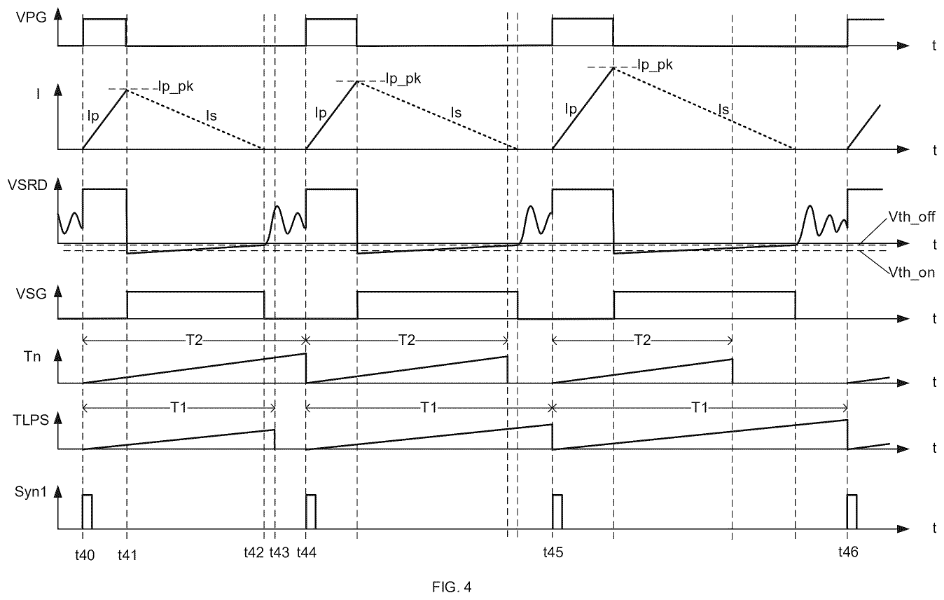

FIG. 4 schematically shows waveforms of signals of the power system 20 in accordance with one embodiment of the present disclosure. The working principle of the power system 20 applying the secondary control circuit 304 is described below with reference to FIGS. 2, 4 and 5.

In FIG. 4, at time t40, the primary switch control signal VPG turns on the primary switch 201, the primary current Ip flowing through the primary winding 251 and the primary switch 201 increases, the primary winding 251 stores energy.

At time t41, when the primary current Ip increases to the primary peak current Ip_pk, the primary switch control signal VPG turns off the primary switch 201. Then, the secondary driving control circuit 210 detects that the secondary switch voltage VSRD of the secondary switch 202 decreases to the secondary switch on threshold Vth_on, and therefore the secondary driving control circuit 210 provides the secondary switch control signal VSG to turn on the secondary switch 202. At this time, the energy stored in the primary winding 251 is transferred to the secondary winding 252, and the secondary current Is starts to decrease from a maximum value.

In the actual waveforms of signals of the circuit, the primary peak current Ip_pk of the primary current Ip is proportional to a secondary peak current Is_pk of the secondary current Is. The proportional coefficient is determined by the turns ratio of the primary winding 251 to the secondary winding 252, i.e., Ip_pk:Is_pk=Ns:Np. In the waveforms as shown in FIG. 4, for clarity of the illustration, the turns ratio of the primary winding 251 to the secondary winding 252 is set to 1, i.e., Ns:Np=1:1. Thus, the primary peak current Ip_pk of the primary current Ip is equal to the secondary peak current Is_pk of the secondary current Is. Persons of ordinary skill in the art should understand that the secondary peak current Is_pk of the secondary current Is may not be equal to the primary peak current Ip_pk of the primary current Ip when the turns ratio of the primary winding 251 to secondary winding 252 is not equal to 1.

At time t42, the secondary current Is decreases to zero, the secondary driving control circuit 210 detects that the secondary switch voltage VSRD increases to the secondary switch off threshold Vth_off, and therefore the secondary driving control circuit 210 provides the secondary switch control signal VSG to turn off the secondary switch 202. Then, the secondary switch voltage VSRD starts to oscillate.

At time t43, the first duration T1 indicated by the switching time control signal TLPS provided by the duty cycle control circuit 307 ends. The first duration T1 starts from the turn-on time of the primary switch 201, and the length of the first duration T1 is calculated according to the equation T1=Ton/Dmax as previously described.

At time t44, the second duration T2 indicated by the feedback frequency control signal Tn provided by the feedback frequency control circuit 309 ends. In the embodiment of FIG. 4, the second duration T2 starts from the turn-on time of the primary switch 201. The length of the second duration T2 is determined by the feedback signal Vcomp, i.e., determined by the load condition. In the switching cycle of t40-t44, the second duration T2 ends later than the first duration T1, and thus the switching period Ts of the voltage conversion circuit 200 ends after the second duration T2 ends. At time t44 (i.e., the end time of the second duration T2), the secondary driving control circuit 210 provides the switching release signal Syn1 to indicate that the switching cycle ends, and the primary switch 201 is required to be turned on. After receiving the switching release signal Syn2, the primary control circuit 206 provides the primary switch control signal VPG to turn on the primary switch 201. At this point, one switching cycle of the voltage conversion circuit 200 ends. In other words, in the switching cycle of t40-t44, the switching period Ts of the voltage conversion circuit 200 is equal to the second duration T2.

In the switching cycle of t44-t45, due to the load increases, the second duration T2 decreases. Furthermore, the primary peak current Ip_pk of the primary current Ip increases as the load increases, the on-period of the primary switch 201 increases, the energy stored in the primary winding 251 increases, and thus the on-period Ton of the secondary switch 202 increases. According to T1=Ton/Dmax, the first duration T1 increases. As shown in FIG. 4, in the switching cycle of t44-t45, the first duration T1 ends later than the second duration T2. At time t45 (i.e., the end time of the first duration T1), the switching release signal Syn1 indicates that the switching cycle ends, and the primary switch 201 is required to be turned on. In other words, in the switching cycle of t40-t44, the switching period Ts of the voltage conversion circuit 200 is equal to the first duration T1.

Similarly, in the switching cycle of t45-t46, due to the load further increases, the second duration T2 further decreases and the first duration T1 further increases, the first duration T1 ends later than the second duration T2. At time t46 (i.e., the end time of the first duration T1), the switching release signal Syn1 indicates that the switching cycle ends, and the primary switch 201 is required to be turned on.

As shown in FIG. 4, as the load increases, the second duration T2 decreases continually, and the first duration T1 increases continually. The switching period Ts of the voltage conversion circuit 200 is limited to the first duration T1 when the first duration T1 ends later than the second duration T2, that is, the switching frequency is unable to increase continually. Therefore, the output current Iout of the voltage conversion circuit 200 could be limited.

As illustrated before, the switching period Ts of the voltage conversion circuit 200 is defined as the duration from the turn-on time of the primary switch 201 to the next turn-on time of the primary switch 201. It should be understood, the switching period Ts of the voltage conversion circuit 200 is equal to the switching period of the primary switch 201 or the secondary switch 202. For example, the switching period Ts of the voltage conversion circuit 200 may be the duration from the turn-on time of the secondary switch 202 to the next turn-on time of the secondary switch 202. For another example, the switching period Ts of the voltage conversion circuit 200 may be the duration from the turn-off time of the secondary switch 202 to the next turn-off time of the secondary switch 202.

In the embodiment of FIG. 4, the first duration T1 and the second duration T2 start from the turn-on time of the primary switch 201. The first duration T1 is indicated by the switching time control signal TLPS with an increased voltage signal, and the end of the first duration T1 is indicated by the falling edge of the increased voltage signal. The second duration T2 is indicated by the feedback frequency control signal Tn with another increased voltage signal, and the end of the second duration T2 is indicated by the falling edge of the increased voltage signal. In other embodiments, the first duration T1 and the second duration T2 may starts from the different time. For example, in one embodiment, the first duration T1 starts from the turn-on time of the primary switch 201, and the second duration T2 starts from the turn-on time of the secondary switch 202. It should be understood that, the first duration T1 and the second duration T2 may be indicated by the switching time control signal TLPS and the feedback frequency control signal Tn with other signal forms, such as a high voltage level or a low voltage level. The start and end times of the first duration T1 and the second duration T2 could be indicated by other signal forms, such as a rising edge or a falling edge.

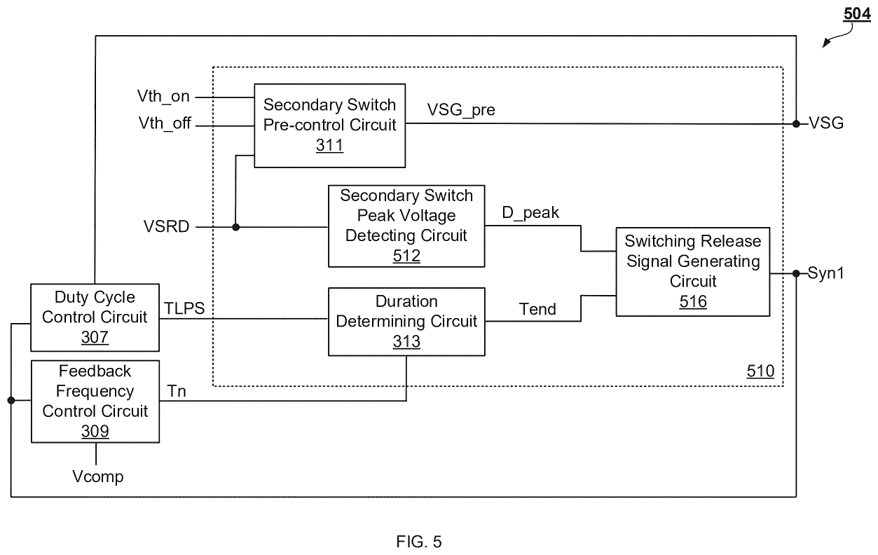

In some embodiments, the voltage conversion circuit 200 adopts quasi-resonant control method to decrease the switching loss. In these embodiments, after the first duration T1 and the second duration T2 both end, the primary switch 201 could be turned on. The control circuit 203 further detects the primary switch voltage VPDS and turns on the primary switch 201 when the primary switch voltage VPDS reaches its valley. FIG. 5 schematically shows a secondary control circuit 504 in accordance with one embodiment of the present disclosure. The secondary control circuit 504 may be used in the power system 20 as shown in FIG. 2. The secondary control circuit 504 includes the duty cycle control circuit 307, the feedback frequency control circuit 309 and a secondary driving control circuit 510.

The duty cycle control circuit 307 is configured to provide the switching time control signal TLPS based on the switching release signal Syn1 and the on-period Ton of the secondary switch 202. The feedback frequency control circuit 309 is configured to provide the feedback frequency control signal Tn based on the feedback signal Vcomp and the switching release signal Syn1.

The secondary driving control circuit 510 includes the secondary switch pre-control circuit 311, a secondary switch peak voltage detecting circuit 512, the duration determining circuit 313 and a switching release signal generating circuit 516. The working principles of the secondary switch pre-control circuit 311 and the duration determining circuit 313 are same as those in the embodiment of FIG. 3 and will not be repeated herein.

In the embodiment of FIG. 5, the secondary switch pre-control signal VSG_pre provided by the secondary switch pre-control circuit 311 is used directly as the secondary switch control signal VSG for controlling the secondary switch 202.

In the embodiment of FIG. 5, the secondary switch peak voltage detecting circuit 512 is configured to provide a peak voltage detecting signal D_peak based on the secondary switch voltage VSRD. The peak voltage detecting signal D_peak indicates that the secondary switch voltage VSRD reaches its oscillation peak. It should be appreciated that, the time when the secondary switch voltage VSRD reaches its oscillation peak corresponds to the time when the primary switch voltage VPDS reaches its valley. In some embodiments, the detection of the oscillation peak of the secondary switch voltage VSRD may be realized by detecting the value or the slew rate of the secondary switch voltage VSRD.

The switching release signal generating circuit 516 is configured to receive the peak voltage detecting signal D_peak and the switching time pre-determining signal Tend, and to provide the switching release signal Syn1 to turn on the primary switch 201. In some embodiments, the primary switch 201 is turned on when the switching time pre-determining signal Tend indicates that the first duration T1 and the second duration T2 both end, and the peak voltage detecting signal D_peak indicates that the secondary switch voltage VSRD reaches its oscillation peak.

It should be understood that, due to delays probably existing in realistic circuits, there might be a deviation between the time when the switching release signal Syn1 indicates that the primary switch 201 could be turned on and the actual turn-on time of the primary switch 201. Therefore, in practice application, the switching release signal Syn1 should be sent in advance, that is, the switching release signal Syn1 should be sent before the secondary switch voltage VSRD reaches its oscillation peak, and thus the primary switch 201 could be turned on at the time when the primary switch voltage VPDS reaches its valley. In other words, the peak voltage detecting signal D_peak provided by the secondary switch peak voltage detecting circuit 512 may not accurately corresponds to the time when secondary switch voltage VPDS reaches its oscillation peak. For example, due to the circuit delay, the peak voltage detecting signal D_peak is provided before the secondary switch voltage VPDS reaches its oscillation peak.

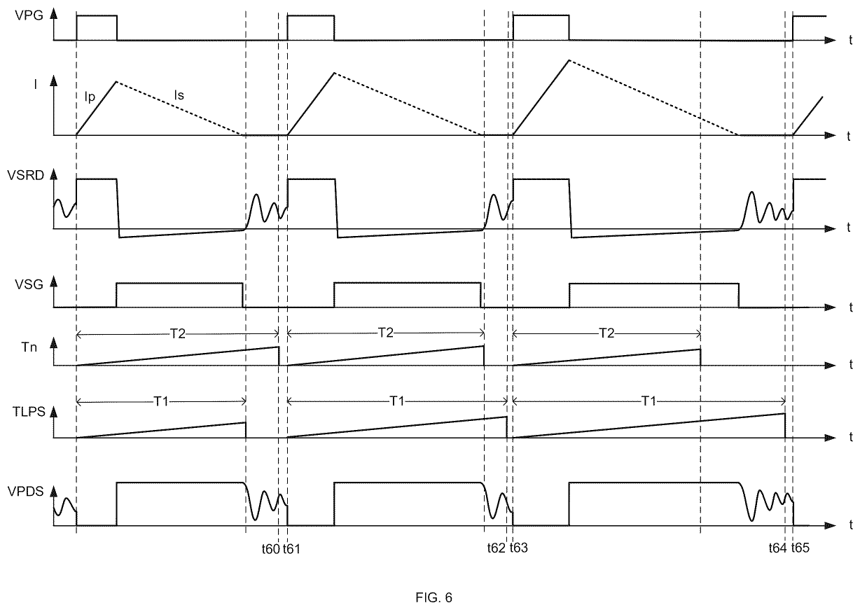

FIG. 6 schematically shows waveforms of signals of the power system 20 in accordance with one embodiment of the present disclosure. In the embodiment of FIG. 6, the power system 20 adopts the secondary control circuit 504. As shown in FIG. 6, at time t60, the first duration T1 and the second duration T2 both end, but the primary switch 201 is turned on at the time when the primary switch voltage VPDS decreases to its valley (i.e., at time t61). At time t62, the first duration T1 and the second duration T2 both end. At time t63, the primary switch voltage VPDS decreases to its valley, the primary switch 201 is turned on. At time t64, the first duration T1 and the second duration T2 both end. At time t65, the primary switch voltage VPDS decreases to its valley, the primary switch 201 is turned on.

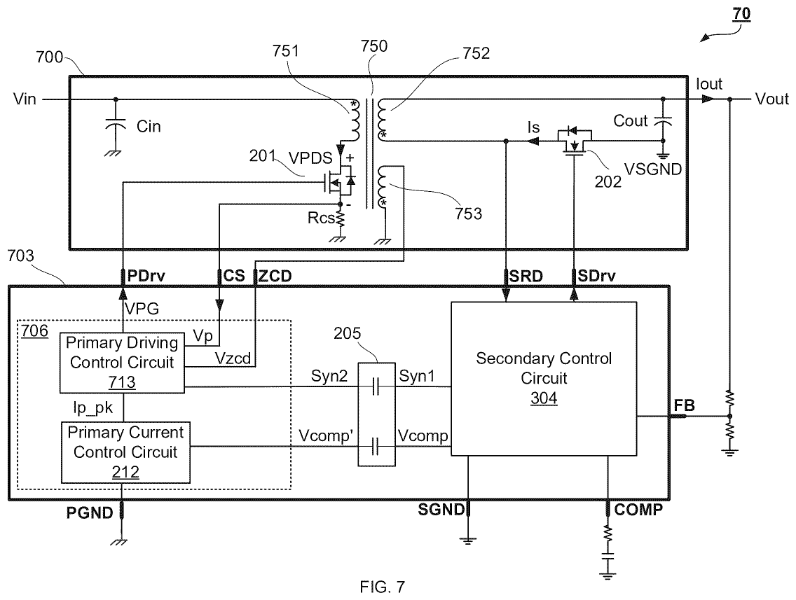

In some embodiments, the valley of the primary switch voltage VPDS may be detected in other ways. FIG. 7 schematically shows a power system 70 in accordance with one embodiment of the present disclosure. In the embodiment of FIG. 7, the voltage conversion circuit 700 includes a transformer 750. The transformer 750 includes a primary winding 751, a secondary winding 752 and an auxiliary winding 753. A control circuit 703 includes a primary control circuit 706, the isolated circuit 205 and the secondary control circuit 304. The working principle of the secondary control circuit 304 is illustrated before. The auxiliary winding 753 is configured to detect the drain voltage of the primary switch 201 (i.e., the primary switch voltage VPDS), and to provide a zero-crossing detecting signal Vzcd based on the primary switch voltage VPDS.

In the embodiment of FIG. 7, the zero-crossing detecting signal Vzcd is provided to the primary control circuit 706 through a pin ZCD. The primary control circuit 706 is configured to provide the primary switch control signal VPG to turn on the primary switch 201 based on the current sense signal Vp, the feedback signal Vcomp′, the zero-crossing detecting signal Vzcd and the switching release signal Syn2. The zero-crossing detecting signal Vzcd indicates the primary switch voltage VPDS. In some embodiments, the slew rate of the zero-crossing detecting signal Vzcd is detected by the primary control circuit 706 to obtain the time when the primary switch voltage VPDS reaches its valley. The method of using the auxiliary winding 753 to detect the primary switch voltage VPDS across the primary switch 201 is well known by persons skilled in the art and will not be described herein.

In the embodiment of FIG. 7, the primary control circuit 706 includes the primary current control circuit 212 and a primary driving control circuit 713. The primary current control circuit 212 is configured to provide the primary peak current Ip_pk based on the received feedback signal Vcomp′. The primary driving control circuit 713 is configured to provide the primary switch control signal VPG based on the current sense signal Vp, the primary peak current Ip_pk, the switching release signal Syn2 and the zero-crossing detecting signal Vzcd. When the switching release signal Syn2 indicates that the primary switch 201 could be turned on, and the zero-crossing detecting signal Vzcd indicates that the primary switch voltage VPDS reaches its oscillation valley, the primary switch control signal VPG turns on the primary switch 201, the primary current Ip increases. When the current sense signal Vp indicates that the primary current Ip increases to the primary peak current Ip_pk, the primary switch control signal VPG turns off the primary switch 201.

To further eliminate the switching noise, the primary switch 201 may be set to be turned on at a specific valley. Therefore, in some embodiments, after the first duration T1 and the second duration T2 both end, the primary switch 201 may not be turned on at the first valley of the primary switch voltage VPDS. In other words, the primary switch 201 may be turned on at the M^{th} valley of the primary switch voltage VPDS, where M is a natural number greater than 0 that could be set.

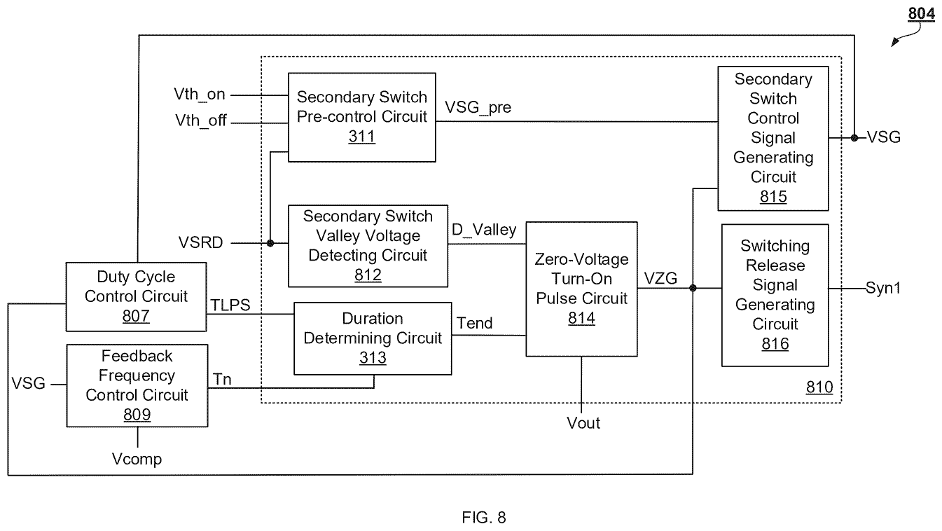

In some embodiments, in order to reduce the switching loss, the voltage conversion circuit 200 adopts zero voltage switching control method. That is, before the primary switch 201 is turned on, the primary switch voltage VPDS across the primary switch 201 is pulled down to zero or close to zero. FIG. 8 schematically shows a secondary control circuit 804 in accordance with one embodiment of the present disclosure. The secondary control circuit 804 may be used in the control circuit 203.

As shown in FIG. 8, the secondary control circuit 804 includes a duty cycle control circuit 807, a feedback frequency control circuit 809 and a secondary driving control circuit 810.

The duty cycle control circuit 807 is configured to provide the switching time control signal TLPS based on the on-period Ton of the secondary switch 202. The switching time control signal TLPS indicates the first duration T1. In the embodiment of FIG. 8, the on-period Ton of the secondary switch 202 is detected based on the secondary switch control signal VSG. Meanwhile, the duty cycle control circuit 807 is configured to set the start time of the first duration T1 based on a zero-voltage turn-on control signal VZG. The zero-voltage turn-on control signal VZG controls the secondary switch 202 to turn on for a period of time before the primary switch 201 is turned on, to generate the negative secondary current Is (i.e., the secondary current Is flows from the secondary winding 752 through the secondary switch 202 to the secondary ground VSGND), thereby realizing the zero-voltage turn-on of the primary switch 201. In some embodiments, the duty cycle control circuit 807 includes a timing circuit. The timing circuit is configured to start timing from the time when the zero-voltage turn-on control signal VZG is enabled (i.e., the time when the secondary switch 202 is turned on), and to provide the switching time control signal TLPS to indicate the end of the first duration T1.

The feedback frequency control circuit 809 is configured to provide the feedback frequency control signal Tn based on the feedback signal Vcomp and the secondary switch control signal VSG. The feedback frequency control signal Tn indicates the second duration T2. The length of the second duration T2 is determined by the feedback signal Vcomp. In one embodiment, the feedback frequency control circuit 809 includes a voltage-controlled oscillator and a timing circuit. The voltage-controlled oscillator is configured to generate the second duration T2 based on the feedback signal Vcomp. The timing circuit is configured to start timing from the time when the primary switch 201 is turned off (i.e., the secondary switch 202 is turned on), and to provide the feedback frequency control signal Tn to indicate the end of the second duration T2. It should be appreciated tht, there is a dead time between the turn-off time of the primary switch 201 and the turn-on time of the secondary switch 202, and the dead time could be negligible. In the embodiment of FIG. 8, the feedback frequency control circuit 809 determines the turn-off time of the primary switch 201 and the turn-on time of the secondary switch 202 based on the secondary switch control signal VSG. It should be understood that the turn-off time of the primary switch 201 and the turn-on time of the secondary switch 202 may also be determined based on other signals. Moreover, the second duration T2 may also start from any time of the switching cycle. For example, in the embodiment of FIG. 3, the second duration T2 starts from the turn-on time of the primary switch 201.

The secondary driving control circuit 810 includes the secondary switch pre-control circuit 311, a secondary switch valley voltage detecting circuit 812, the duration determining circuit 313, a zero-voltage turn-on pulse circuit 814, a secondary switch control signal generating circuit 815 and a switching release signal generating circuit 816.

The working principles of the secondary switch pre-control circuit 311 and the duration determining circuit 313 are same as those in the embodiment of FIG. 3 and will not be repeated herein.

The secondary switch valley voltage detecting circuit 812 is configured to provide a valley voltage detecting signal D_valley based on the secondary switch voltage VSRD. The secondary switch valley voltage detecting circuit 812 is configured to detect the secondary switch voltage VSRD, and to provide the valley voltage detecting signal D_valley. The valley voltage detecting signal D_valley indicates that the secondary switch voltage VSRD reaches its oscillation valley. In one embodiment, the valley voltage detecting signal D_valley is enabled (e.g. indicated by a pulse) when the secondary switch voltage VSRD reaches the oscillation valley.

In one embodiment, the valley detection of the secondary switch voltage VSRD may be realized by detecting the value of the secondary switch voltage VSRD. For example, when the secondary switch voltage VSRD is less than a value close to zero, it is determined that the secondary switch voltage VSRD reaches the oscillation valley. In one embodiment, the valley detection of the secondary switch voltage VSRD may be realized by detecting the slew rate of the secondary switch voltage VSRD. For example, when the slew rate of the secondary switch voltage VSRD increases from a negative value to zero, it is determined that the secondary switch voltage VSRD reaches the oscillation valley. Other circuits that are suitable for detecting the oscillation valley of the voltage could be utilize in the present disclosure.

The zero-voltage turn-on pulse circuit 814 is configured to provide the zero-voltage turn-on control signal VZG based on the valley voltage detecting signal D_valley and the switching time pre-determining signal Tend. After the switching time pre-determining signal Tend indicates that the first duration T1 and the second duration T2 both end, the zero-voltage turn-on control signal VZG generates a pulse when the voltage valley detecting signal D_valley indicates that the secondary switch voltage VSRD reaches the oscillation valley. In one embodiment, the pulse width of the zero-voltage turn-on control signal VZG increases as the output voltage Vout decreases and decreases as the output voltage Vout increases. In one embodiment, the pulse width of the zero-voltage turn-on control signal VZG increases as the input voltage Vin decreases and decreases as the input voltage Vin increases. In one embodiment, the pulse width of the zero-voltage turn-on control signal VZG is controlled by the input voltage Vin and the output voltage Vout. For example, the pulse width of the zero-voltage turn-on control signal VZG increases as the input voltage Vin increases and decreases as the input voltage Vin decreases. For another example, the pulse width of the zero-voltage turn-on control signal VZG increases as the output voltage Vout decreases and decreases as the output voltage Vout increases.

In the embodiment of FIG. 8, the output voltage Vout is provided to the zero-voltage turn-on pulse circuit 814 to control the pulse width of the zero-voltage turn-on control signal VZG. The output voltage Vout may be obtained by different ways. For example, the output voltage Vout may be obtained based on the load detecting signal Vfb. For another example, the output voltage Vout may be obtained based on the voltage of a power supply circuit. In some embodiments, the pulse width of the zero-voltage turn-on control signal VZG is fixed and could be set according to circuit specification and application requirements.

The secondary switch control signal generating circuit 815 is configured to provide the secondary switch control signal VSG based on the secondary switch pre-control signal VSG_pre and the zero-voltage turn-on control signal VZG. When the secondary switch pre-control signal VSG_pre indicates that the secondary switch 202 is turned on, the secondary switch control signal VSG is synchronized with the secondary switch pre-control signal VSG_pre. When the secondary switch pre-control signal VSG_pre indicates that the secondary switch 202 is turned off, the secondary switch control signal VSG is synchronized with the secondary switch pre-control signal VSG_pre. When the zero-voltage turn-on control signal VZG generates the pulse, the secondary switch control signal VSG is synchronized with the zero-voltage turn-on control signal VZG. In one embodiment, the secondary switch 202 is turned on when the pulse of the secondary switch control signal VSG is at a high voltage level, and the secondary switch 202 is turned on when the secondary switch pre-control signal VSG_pre is at a high voltage level. In one embodiment, the secondary switch control signal generating circuit 815 includes an AND gate. The AND gate is configured to perform the AND operation on the zero-voltage turn-on control signal VZG and the secondary switch pre-control signal VSG_pre to provide the secondary switch control signal VSG.

After the pulse of the zero-voltage turn-on control signal VZG turns on the secondary switch 202, the negative current is generated in the secondary winding 252. When the pulse of the zero-voltage turn-on control signal VZG ends, the secondary switch 202 is turned off, and the negative current is fed back to the primary winding 251 to discharge the source-drain capacitor across the primary switch 201. Therefore, the primary switch voltage VPDS across the primary switch 201 could oscillate to zero or close to zero. The primary switch 201 is turned on when the primary switch voltage VPDS across the primary switch 201 is zero or close to zero to realize the zero-voltage turn-on of the primary switch 201, thereby reducing the switching loss and improving the efficiency.

The switching release signal generating circuit 816 is configured to generate the switching release signal Syn1 based on the zero-voltage turn-on control signal VZG. In one embodiment, when the pulse of the zero-voltage turn-on control signal VZG ends, the switching release signal Syn1 indicates that the primary switch 201 is turned on. That is, after the secondary switch 202 is turned off based on the pulse of the zero-voltage turn-on control signal VZG, the primary switch 201 is turned on. It should be understood that, due to the delay existing in the realistic circuit, the switching release signal Syn1 may be generated the pulse before the pulse of the zero-voltage turn-on control signal VZG ends. The pulse generated by the switching release signal Syn1 is provided to the primary control circuit 206 such that the primary switch 201 could be turned on timely after the secondary switch 202 is turned off.

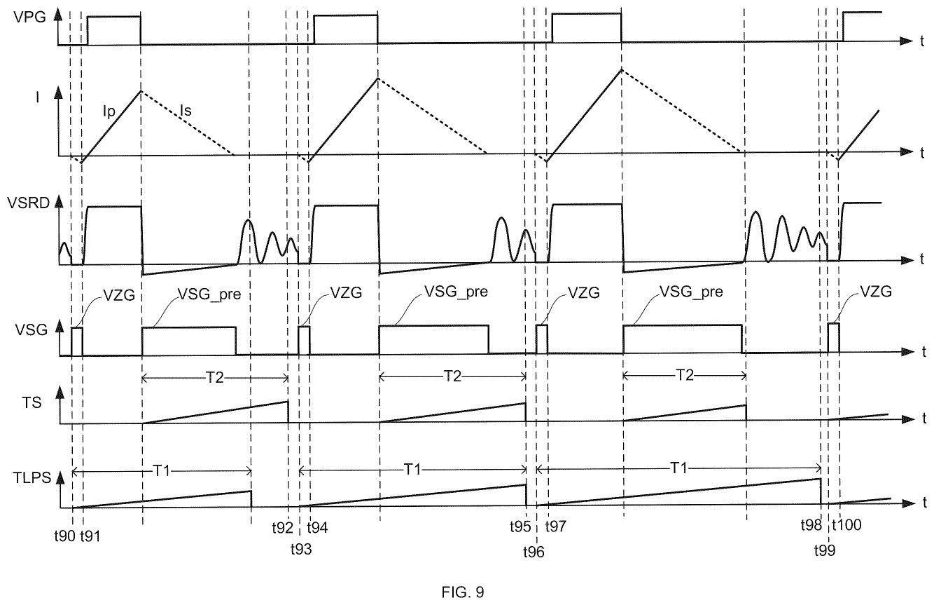

FIG. 9 schematically shows waveforms of signals of the power system 20 in accordance with one embodiment of the present disclosure. The power system 20 adopts the secondary control circuit 804. The working principle of the secondary control circuit 804 is described below with reference to FIGS. 8 and 9.

As shown in FIG. 9, at time t90, the secondary switch voltage VSRD reaches its oscillation valley, the zero-voltage turn-on control signal VZG generates a pulse. The pulse is added to the secondary switch control signal VSG for turning on the secondary switch 202. When the pulse of the zero-voltage turn-on control signal VZG ends, the secondary switch 202 is turned off, the primary switch control signal VPG turns on the primary switch 201. In one embodiment, the primary switch control signal VPG transitions to a high voltage level to turn on the primary switch 201. In other words, the high voltage level state of the primary switch control signal VPG corresponds to the on-state of the primary switch 201. It should be understood that, after the secondary switch 202 is turned off, the source-drain capacitor of the primary switch 201 would be discharged, and the primary switch voltage VPDS needs certain time to decrease to zero or close to zero. Therefore, as shown in FIG. 9, the primary switch 201 is turned on after a delay time from the time when the secondary switch 201 is turned off to realize the zero-voltage turn-on of the primary switch 201.

In the switching cycle of t90-t93, the first duration T1 ends earlier than the second duration T2. Therefore, after time t92 (i.e., after the end time of the second duration T2), at time t93, the valley of the secondary switch voltage VSRD is detected, the zero-voltage turn-on control signal VZG generates the pulse to turn on the secondary switch 202.

At time t94, the pulse of the zero-voltage turn-on control signal VZG ends, the primary control circuit 206 turns on the primary switch 201. In one embodiment, the primary control circuit 206 may further detect the primary switch voltage VPDS and turns on the primary switch 201 after the primary switch voltage VPDS decreases to zero or close to zero. In one embodiment, the primary switch voltage VPDS is detected based on the zero-crossing detecting signal Vzcd as shown in the embodiment of FIG. 7. In some embodiments, the primary control circuit 206 turns on the primary switch 201 after the delay time from when the pulse of the zero-voltage turn-on control signal VZG ends, to ensure that the primary switch voltage VPDS across the primary switch 201 could be decease to zero or close to zero. The delay time corresponds to the discharge time of the source-drain capacitor of the primary switch 201.

In the switching cycle of t93-t96, the first duration T1 and the second duration T2 end at time t95. Afterwards, at time t96, the valley of the secondary switch voltage VSRD is detected, the zero-voltage turn-on control signal VZG generates the pulse to turn on the secondary switch 202. Similarly, at time t97, the pulse of the zero-voltage turn-on control signal VZG ends, the primary switch 201 is turned on after the primary switch voltage VPDS decreases to zero or close to zero.

In the switching cycle of t96-t99, the first duration T1 ends later than the second duration T2. Therefore, after the time t98 (i.e., the end time of the first duration T1), at time t99, the valley of the secondary switch voltage VSRD is detected, the zero-voltage turn-on control signal VZG generates the pulse to turn on the secondary switch 202. Similarly, at time t100, the pulse of the zero-voltage turn-on control signal VZG ends, the primary switch 201 is turned on after the primary switch voltage VPDS decreases to zero or close to zero.

In the embodiment of FIG. 9, the secondary switch 202 is turned on (i.e., the secondary switch VSRD transitions to the high voltage level) twice between two adjacent turning on of the primary switch 201 (i.e., the primary switch voltage VPDS transitions to the high voltage level). The first turning on of the secondary switch 202 is adjacent to the previous turning on of the primary switch 201, and the second turning on of the secondary switch 202 is adjacent to the latter turning on of the primary switch 201. In other words, the first turning on of the secondary switch 202 is controlled by the secondary switch pre-control signal VSG_pre, and the second turning on of the secondary switch 202 is controlled by the pulse of the zero-voltage turn-on control signal VZG. To be specific, the primary switch 201 is turned on and then is turned off, after the primary switch 201 is turned off, the secondary switch 202 is turned on for the first time. Subsequently, the secondary switch 202 is turned on for the second time and then is turned off, after the secondary switch 202 is turned off, the primary switch 201 is turned on again. The second turning on of the secondary switch 202 (which is controlled by the pulse of the zero-voltage turn-on control signal VZG) results in the primary switch voltage VPDS across the primary switch 202 being decreased to zero or close to zero.

In the embodiments of FIGS. 8 and 9, the secondary switch valley voltage detecting circuit 812 detects the valley of the secondary switch voltage VSRD, after the first duration T1 and the second duration T2 end, the zero-voltage turn-on pulse circuit 814 turns on the secondary switch 202 at the valley of the secondary switch voltage VSRD to reduce the switching loss. It should be understood that, in some cases, for example, when the switching loss is low or has no effect on the practical application, the secondary switch 202 could be turned on when the first duration T1 and the second duration T2 end without waiting for the valley of the secondary switch voltage VSRD.

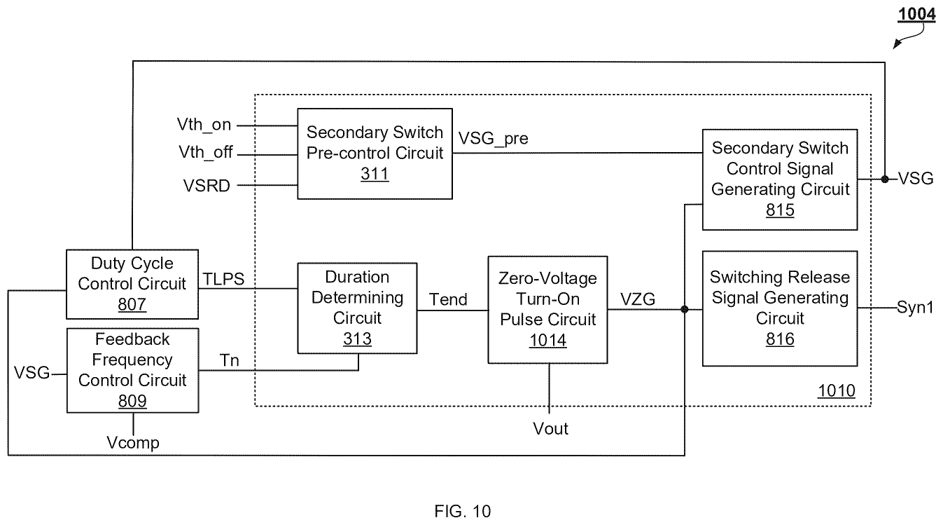

FIG. 10 schematically shows a secondary control circuit 1004 in accordance with one embodiment of the present disclosure. Compared to the embodiment of FIG. 8, in the embodiment of FIG. 10, the secondary driving control circuit 1010 does not detect the valley of the secondary switch voltage VSRD. The zero-voltage turn-on pulse circuit 1014 is configured to provide the zero-voltage turn-on control signal VZG to turn on the secondary switch 202 after the switching period pre-determination signal Tend indicates that the first duration T1 and the second duration T2 both end. The working principle of the secondary control circuit 1004 is similar to that of the secondary control circuit 804 and will not be described herein.

It should be understood that the first duration T1 indicates a preset switching period. As described previously, the start and end times of the switching cycle are not fixed. For example, in some previous embodiments, the switching cycle starts from the turn-on time of the primary switch 201 and ends at the next adjacent turn-on time of the primary switch 201. Accordingly, the first duration T1 starts from the turn-on time of the primary switch 201. However, in the embodiment of FIG. 9, the first duration T1 starts from the start time of the pulse of the zero-voltage turn-on control signal VZG (e.g., t90, t93, t96, 199 as shown in FIG. 9). In other words, in the embodiment of FIG. 9, the switching cycle start from the start time of the pulse of the zero-voltage turn-on control signal VZG and ends at the next adjacent start time of the pulse of the zero-voltage turn-on control signal VZG. The switching period from the start time of the pulse of the zero-voltage turn-on control signal VZG to the next adjacent start time of the pulse of the zero-voltage turn-on control signal VZG is equal to the switching period from the turn-on time of the primary switch 201 to the next adjacent turn-on time of the primary switch 201. It should be understood that the pulse of the zero-voltage turn-on control time VZG is used to realize the zero-voltage turn-on of the primary switch 201, and the width of the pulse is negligible relative to the entire switching period of the primary switch 201. In other words, in the embodiment of FIG. 9, it could be approximated that the first duration T1 starts from the turn-on time of the primary switch 201.

In some embodiments of the present disclosure, in the quasi-resonant control method or the zero-voltage control method, the time when the first duration T1 and the second duration T2 both end may not accurately correspond to the time when the switching period Ts ends. However, it should be understood that in the quasi-resonant control method, after the first duration T1 and the second duration T2 both end, to realize the quasi-resonant control, the primary switch 201 is turned on when the primary switch voltage VPDS reaches the valley. In this case, the deviation between the time when the first duration T1 and the second duration T2 both end and the actual time when the switching period Ts ends is relatively small or even negligible. Similarly, in the zero-voltage control method, the deviation between the time when the first duration T1 and the second duration T2 both end and the actual time when the switching period Ts ends is also relatively small or even negligible.

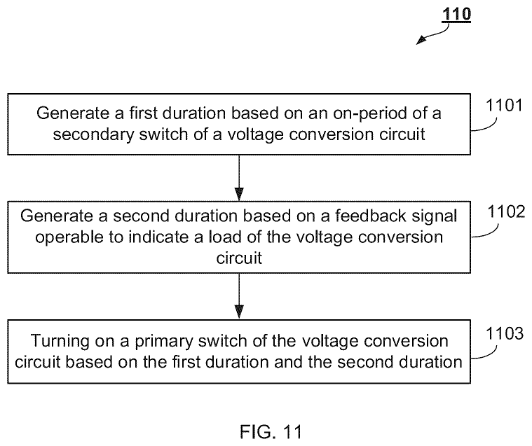

FIG. 11 shows a flowchart of a method 110 for controlling a voltage conversion circuit in accordance with one embodiment of the present disclosure. The voltage conversion circuit includes a primary switch, a secondary switch and a transformer. The transformer includes a primary winding coupled to the primary switch and a secondary winding coupled to the secondary switch. The voltage conversion circuit may include one of the voltage conversion circuit 100, the voltage conversion circuit 200, the voltage conversion circuit 700 in the aforementioned embodiments, and other suitable switching circuits.

As shown in FIG. 11, the method 110 includes actions 1101-1103. In action 1101, a first duration is generated based on the on-period of the secondary switch of the voltage conversion circuit. In action 1102, a second duration is generated based on a feedback signal operable to indicate the load of the voltage conversion circuit. In action 1103, the primary switch of the voltage conversion circuit is turned on based on the first duration and the second duration.

In one embodiment, the ratio of the on-period of the secondary switch of the voltage conversion circuit to the first duration is a constant value.

In one embodiment, the ratio of the on-period of the secondary switch of the voltage conversion circuit to the first duration is selected from a plurality of constant values.

In one embodiment, the ratio of the on-period of the secondary switch of the voltage conversion circuit to the first duration changes based on an output voltage of the voltage conversion circuit.

In one embodiment, the first duration starts from the turn-on time of the primary switch of the voltage conversion circuit.

In one embodiment, the action 1103 includes a following action. After the first duration and second duration both end, the primary switch is turned on at a valley of a voltage across the primary switch. The first duration starts from the turn-on time of the primary switch of the voltage conversion circuit.

In one embodiment, the secondary switch is turned on twice between the two adjacent turning on of the primary switch. The first turning on of the secondary switch is adjacent to the previous turning on of the primary switch, and the second turning on of the secondary switch is adjacent to the latter turning on of the primary switch. To be specific, the primary switch is turned on and then is turned off, after the primary switch is turned off, the secondary switch is turned on for the first time. Subsequently, the secondary switch is turned on for the second time and then is turned off, after the secondary switch is turned off, the primary switch is turned on again. The second turn-on of the secondary switch results in the voltage across the primary switch being decreased to zero or close to zero.

In one embodiment, the method 110 further includes an action 1104. In action 1104, after the first duration and the second duration both end and before the primary switch of the voltage conversion circuit is turned on, the secondary switch is controlled to be turned on for a zero-voltage control duration, and the primary switch is turned on after the zero-voltage control duration ends.

In some embodiments, the method 110 further includes an action 1105. In action 1105, after the first duration and second duration both end and before the primary switch of the voltage conversion circuit is turned on, the secondary switch is turned on when a voltage across the secondary switch reaches a valley, and the secondary switch is controlled to be turned on for the zero-voltage control duration, the primary switch is turned on after the zero-voltage control duration ends.

In one embodiment, the first duration starts from the time when the zero-voltage control duration starts.

In one embodiment, the second duration decreases as the load increases and increases as the load decreases.

In one embodiment, the second duration and the first duration start at the same time.

In one embodiment, the second duration starts from the time when the primary switch is turned off.

In one embodiment, the second duration starts from the time when the secondary switch is turned on.

In one embodiment, the method 110 further includes an action 1106. In action 1106, the primary switch is turned off when the current flowing through the primary switch reaches a peak current.

In one embodiment, the peak current is a constant value.

In one embodiment, the peak current increases as the load of the voltage conversion circuit increases and decreases as the load of the voltage conversion circuit decreases.

It is noted that the actions of the method 110 can also perform in a different sequence. For example, two consecutive blocks shown in FIG. 11, in fact, can be executed substantially concurrently, or they may sometimes be executed in the reverse order, depending upon the particular function involved.

In the present invention, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a voltage conversion circuit, comprising:
a duty cycle control circuit configured to provide a switching time control signal based on an on-period of a secondary switch of the voltage conversion circuit, wherein the switching time control signal indicates a first duration;
a feedback frequency control circuit configured to provide a feedback frequency control signal based on a feedback signal operable to indicate a load of the voltage conversion circuit, wherein the feedback frequency control signal indicates a second duration; and
a secondary driving control circuit configured to provide a switching release signal based on the switching time control signal and the feedback frequency control signal, wherein the switching release signal is configured to turn on a primary switch of the voltage conversion circuit in response to the first duration and the second duration.

2. The control circuit of claim 1, wherein a ratio of the on-period of the secondary switch of the voltage conversion circuit to the first duration is a constant value.

3. The control circuit of claim 1, wherein a ratio of the on-period of the secondary switch of the voltage conversion circuit to the first duration is selected from a plurality of constant values.

4. The control circuit of claim 1, wherein a ratio of the on-period of the secondary switch of the voltage conversion circuit to the first duration changes based on an output voltage of the voltage conversion circuit.

5. The control circuit of claim 1, wherein the second duration decreases when the load of the voltage conversion circuit increases.

6. The control circuit of claim 1, wherein the secondary driving control circuit comprises:
a duration determining circuit configured to provide a switching time pre-determining signal based on the switching time control signal and the feedback frequency control signal, wherein the switching time pre-determining signal indicates a time when the first duration and the second duration both end; and
a switching release signal generating circuit configured to provide the switching release signal to turn on the primary switch of the voltage conversion circuit based on the switching time pre-determining signal.

7. The control circuit of claim 1, further comprising:
a primary control circuit configured to receive the switching release signal and a zero-crossing detecting signal indicating a primary switch voltage across the primary switch, and to provide a primary switch control signal to turn on the primary switch based on the switching release signal and the zero-crossing detecting signal.

8. The control circuit of claim 1, wherein the secondary driving control circuit comprises:
a duration determining circuit configured to provide a switching time pre-determining signal based on the switching time control signal and the feedback frequency control signal, wherein the switching time pre-determining signal indicates a time when the first duration and the second duration both end;
a secondary switch peak voltage detecting circuit configured to provide a peak voltage detecting signal based on a secondary switch voltage across the secondary switch of the voltage conversion circuit, wherein the peak voltage detecting signal indicates an oscillation peak of the secondary switch voltage; and
a switching release signal generating circuit configured to provide the switching release signal to turn on the primary switch of the voltage conversion circuit based on the switching time pre-determining signal and the peak voltage detecting signal.

9. The control circuit of claim 1, wherein the secondary driving control circuit comprises:
a secondary switch pre-control circuit configured to provide a secondary switch pre-control signal to control the secondary switch based on a secondary switch voltage across the secondary switch.

10. The control circuit of claim 1, wherein the secondary driving control circuit comprises:
a duration determining circuit configured to provide a switching time pre-determining signal based on the switching time control signal and the feedback frequency control signal, wherein the switching time pre-determining signal indicates a time when the first duration and the second duration both end;
a secondary switch valley voltage detecting circuit configured to provide a valley voltage detecting signal based on a secondary switch voltage across the secondary switch of the voltage conversion circuit, wherein the valley voltage detecting signal indicates an oscillation valley of the secondary switch voltage;
a zero-voltage turn-on pulse circuit configured to provide a zero-voltage turn-on control signal based on the valley voltage detecting signal and the switching time pre-determining signal; and
a switching release signal generating circuit configured to provide the switching release signal to turn on the primary switch of the voltage conversion circuit based on the zero-voltage turn-on control signal.

11. The control circuit of claim 1, wherein the secondary driving control circuit comprises:
a duration determining circuit configured to provide a switching time pre-determining signal based on the switching time control signal and the feedback frequency control signal, wherein the switching time pre-determining signal indicates a time when the first duration and the second duration both end;
a zero-voltage turn-on pulse circuit configured to provide a zero-voltage turn-on control signal based on the switching time pre-determining signal; and
a switching release signal generating circuit configured to provide the switching release signal to turn on the primary switch of the voltage conversion circuit based on the zero-voltage turn-on control signal.

12. The control circuit of claim 1, wherein the duty cycle control circuit, the feedback frequency control circuit and the secondary driving control circuit are integrated in a secondary control circuit, and wherein the control circuit further comprises:
a primary control circuit configured to receive the switching release signal, and to provide a primary control signal to control the primary switch of the voltage conversion circuit; and
an isolated circuit configured to provide the switching release signal from the secondary control circuit to the primary control circuit.

13. The control circuit of claim 12, wherein:
the secondary control circuit is further configured to provide the feedback signal;
the isolated circuit is further configured to provide the feedback signal from the secondary control circuit to the primary control circuit; and
the primary control circuit is further configured to receive the feedback signal and a current sense signal indicating a current flowing through the primary switch of the voltage conversion circuit, and to turn off the primary switch of the voltage conversion circuit based on the feedback signal and the current sense signal.

14. A voltage conversion circuit, comprising:
a primary switch configured to receive a primary switch control signal, wherein the primary switch is controlled by the primary switch control signal;
a secondary switch configured to receive a secondary switch control signal, wherein the secondary switch is controlled by the secondary switch control signal;
a transformer having a primary winding and a secondary winding, wherein the primary winding is coupled in series with the primary switch and the secondary winding is coupled in series with the secondary switch; and
a control circuit, comprising:
a duty cycle control circuit configured to provide a switching time control signal based on an on-period of the secondary switch, wherein the switching time control signal indicates a first duration;
a feedback frequency control circuit configured to provide a feedback frequency control signal based on a feedback signal operable to indicate a load of the voltage conversion circuit, wherein the feedback frequency control signal indicates a second duration; and
a secondary driving control circuit configured to provide a switching release signal based on the switching time control signal and the feedback frequency control signal, wherein the switching release signal is configured to turn on the primary switch in response to the first duration and the second duration both end.

15. The voltage conversion circuit of claim 14, wherein a ratio of the on-period of the secondary switch to the first duration is a constant value.

16. The voltage conversion circuit of claim 14, wherein a ratio of the on-period of the secondary switch to the first duration is selected from a plurality of constant values.

17. The voltage conversion circuit of claim 14, wherein a ratio of the on-period of the secondary switch to the first duration changes based on an output voltage of the voltage conversion circuit.

18. A method for controlling a voltage conversion circuit, comprising:
generating a first duration based on an on-period of a secondary switch of the voltage conversion circuit;
generating a second duration based on a feedback signal operable to indicate a load of the voltage conversion circuit; and
turning on a primary switch of the voltage conversion circuit based on the first duration and the second duration.

19. The method of claim 18, wherein a ratio of the on-period of the secondary switch of the voltage conversion circuit to the first duration is a constant value.

20. The method of claim 18, wherein a ratio of the on-period of the secondary switch of the voltage conversion circuit to the first duration changes based on an output voltage of the voltage conversion circuit.
